(19) United States
(12) Patent Application Publication
(10) Pub. No.: US 2015/0009412 A1
(43) Pub. Date: Jan. 8, 2015

(54) VIDEO RECEIVING APPARATUS AND CONTROL METHOD THEREOF

(71) Applicant: SAMSUNG ELECTRONICS CO., LTD., Suwon-si (KR)

(72) Inventor: Dai-boong LEE, Hwaseong-si (KR)

(73) Assignee: SAMSUNG ELECTRONICS CO., LTD., Suwon-si (KR)

(21) Appl. No.: 14/169,757

(22) Filed: Jan. 31, 2014

(30) Foreign Application Priority Data
Jul. 8, 2013 (KR) 10-2013-0079757

(51) Int. Cl. H04N 5/50

(52) U.S. Cl. CPC H04N 5/50
USPC 348/731

(57) ABSTRACT

A video receiving apparatus of a predetermined first group out of a plurality of groups of video receiving apparatuses which receive a broadcasting or broadcast signal from a broad cast or broadcasting signal transmitting apparatus, the video receiving apparatus including: a communication interface which receives a broadcasting signal from the broadcasting signal transmitting apparatus based on tuning information of a channel that is set for the first group separately from the other groups; a processor which processes the broadcasting signal to display a broadcasting video of the channel based on a channel map that is generated by using the tuning information; and a controller which generates and stores the channel map when receiving the broadcasting signal including one or more basic channels, and if it is determined that another video receiving apparatus included in the first group displays a broadcasting video of an additional channel that is not included in the broadcasting signal transmitted when the stored channel map is generated, updates the stored channel map by using tuning information of the additional channel.

### CROSS-REFERENCE TO RELATED APPLICATIONS

This application claims priority from Korean Patent Application No. 10-2013-0079757, filed on Jul. 8, 2013 in the Korean Intellectual Property Office, the disclosure of which is incorporated herein by reference.

### BACKGROUND

1. Field

Apparatuses and methods consistent with the exemplary embodiments relate to a video receiving apparatus and a control method thereof which tunes and processes a broadcasting signal supplied by a broadcasting service provider to thereby display a broadcasting video based on the supplied broadcasting signal, and more particularly, to a video receiving apparatus and a control method thereof configured to reduce a channel zapping time in changing a broadcasting channel and displaying a broadcasting video of another channel.

2. Description of the Related Art

A video receiving apparatus collectively refers to an apparatus to receive a video signal from the outside and process the video signal according to various processes to thereby display a video by the video receiving apparatus or another apparatus. The video receiving apparatus includes a type which has a display panel such as a television (TV) and a computer monitor and displays a video based on a processed video signal, and another type which has no panel like a set-top box and processes a video signal and outputs the processed video signal to another apparatus. For example, if the video receiving apparatus is implemented as a TV or a set-top box, it tunes a broadcasting signal transmitted by a transmitting apparatus of a broadcasting service provider, and processes the broadcasting signal to display a broadcasting video of a particular channel as designated by a user.

The video receiving apparatus stores therein a channel map including tuning information of a broadcasting signal based on system information or service information (SI) provided by a broadcasting service provider. The tuning information includes various information such as frequency or symbol rate to specify a channel from a broadcasting signal transmitted by a broadcasting equipment. For example, since the broadcasting signal of the particular channel includes broadcasting data of a channel transmitted in different frequency bands per channel, the video receiving apparatus should know the frequency of the channel to specify a broadcasting video of the channel from the broadcasting signal. Therefore, if a user selects a channel, the video receiving apparatus tunes to the selected channel from the broadcasting signal based on the information of the channel map.

### SUMMARY

Additional aspects and/or advantages will be set forth in part in the description which follows and, in part, will be apparent from the description, or may be learned by practice of the invention.

A video receiving apparatus of a predetermined first group out of a plurality of groups of video receiving apparatuses which receive a broadcasting or broadcast signal from a broad cast or broadcasting signal transmitting apparatus, the video receiving apparatus including: a communication interface which receives a broadcasting signal from the broadcasting signal transmitting apparatus based on tuning information of a channel that is set for the first group separately from the other groups; a processor which processes the broadcasting signal to display a broadcasting video of the channel based on a channel map that is generated by using the tuning information; and a controller which generates and stores the channel map when receiving the broadcasting signal including one or more basic channels, and if it is determined that another video receiving apparatus included in the first group displays a broadcasting video of an additional channel that is not included in the broadcasting signal transmitted when the stored channel map is generated, updates the stored channel map by using tuning information of the additional channel.

The additional channel may be optionally included in the broadcasting signal transmitted by the broadcasting signal transmitting apparatus to the first group at a request from at least one of the plurality of video receiving apparatuses included in the first group, and the basic channels may be included in the broadcasting signal regardless of the request.

If a user instructs to change a channel to a first channel, the controller may determine whether the first channel is included in the basic channels or the additional channel, and if it is determined that the first channel is the additional channel and the tuning information of the first channel is included in the channel map, may process the broadcasting signal based on the channel map.

If it is determined that the first channel is the additional channel and the tuning information of the first channel is not included in the channel map, the controller may request the broadcasting signal transmitting apparatus to transmit the broadcasting signal including the first channel and the tuning information of the first channel.

If it is determined that the first channel is the basic channel, the controller may process the broadcasting signal based on the channel map.

If the broadcasting signal transmitting apparatus transmits the tuning information of the additional channel that is not included in the stored channel map, the controller may determine that another video receiving apparatus of the first group displays a broadcasting video of an additional channel that is not included in the broadcasting signal transmitted when the stored channel map was generated.

If it is determined that the tuning information of the additional channel that is currently displayed by no other video receiving apparatuses of the first group is included in the stored channel map, the controller may delete the tuning information of the additional channel from the stored channel map.

The inclusion or non-inclusion of the additional channel by the broadcasting signal and the tuning information used to specify the additional channel from the broadcasting signal may commonly apply to the plurality of video receiving apparatuses of the first group.

A frequency band of the additional channel from the broadcasting signal may be individually decided with respect to the plurality of groups, and the tuning information corresponding to the first group may include information used to specify a frequency band of the additional channel from the broadcasting signal transmitted to the first group.

The broadcasting signal may be provided by the broadcasting signal transmitting apparatus to the video receiving apparatus based on a switched digital video (SDV) technology.

A control method of a video receiving apparatus of a predetermined first group out of a plurality of groups of video receiving apparatuses which receive a broadcasting signal from a broadcasting signal transmitting apparatus, the control method including: receiving a broadcasting signal including one or more basic channels which is transmitted by the broadcasting signal transmitting apparatus based on tuning information of a channel that is set for the first group separately from the other groups; generating a channel map based on the tuning information; updating the stored channel map by using tuning information of an additional channel that is not included in the broadcasting signal transmitted when the channel map is generated if it is determined that another video receiving apparatus included in the first group displays a broadcasting video of the additional channel; and processing the broadcasting signal based on the updated channel map if an instruction for changing a channel is received.

The additional channel may be optionally included in the broadcasting signal transmitted by the broadcasting signal transmitting apparatus to the first group at a request from at least one of the plurality of video receiving apparatuses included in the first group, and the basic channels may be included in the broadcasting signal regardless of the request.

The processing the broadcasting signal based on the updated channel map if the instruction for changing the channel is received may include determining whether the first channel is included in the basic channels or the additional channel if a user instructs to change a channel to the first channel; and processing the broadcasting signal based on the channel map if it is determined that the first channel is the additional channel and the tuning information of the first channel is included in the channel map.

The processing the broadcasting signal based on the updated channel map if the instruction for changing the channel is received may further include requesting the broadcasting signal transmitting apparatus to transmit the broadcasting signal including the first channel and the tuning information of the first channel if it is determined that the first channel is the additional channel and the tuning information of the first channel is not included in the channel map.

The processing the broadcasting signal based on the updated channel map if the instruction for changing the channel is received may further include processing the broadcasting signal based on the channel map if it is determined that the first channel is the basic channel.

The updating the stored channel map by using the tuning information of the additional channel may include determining that another video receiving apparatus of the first group displays a broadcasting video of an additional channel that is not included in the broadcasting signal transmitted when the channel map is generated, if the tuning information of the additional channel which is not included in the channel is transmitted by the broadcasting signal transmitting apparatus.

The control method may further include deleting the tuning information of the additional channel from the stored channel map if it is determined that the tuning information of the additional channel that is currently displayed by no other video receiving apparatuses of the first group is included in the stored channel map.

The inclusion or non-inclusion of the additional channel by the broadcasting signal and the tuning information used to specify the additional channel from the broadcasting signal may commonly apply to the plurality of video receiving apparatuses of the first group.

A frequency band of the additional channel in the broadcasting signal may be individually decided for each of the plurality of groups, and the tuning information corresponding to the first group may include information used to specify a frequency band of the additional channel in the broadcasting signal.

The broadcasting signal may be provided by the broadcasting signal transmitting apparatus to the video receiving apparatus based on an SDV technology.

A control method of a video receiving apparatus of a predetermined first group out of a plurality of groups of video receiving apparatuses which receive a broadcasting signal from a broadcasting signal transmitting apparatus, the control method including: generating a channel map comprising a set of channels and tuning information for the channels designated by broadcast service information; updating the channel map to include a channel outside the set when the channel is selected by a user to produce an updated channel map; and changing a channel responsive to the updated channel map when a channel change request occurs.

The method can further include deleting a channel from the map which is outside the set and which is not used.

A control method of a video receiving apparatus of a predetermined first group out of a plurality of groups of video receiving apparatuses which receive a broadcasting signal from a broadcasting signal transmitting apparatus, the control method including: generating a channel map comprising a set of channels and tuning information responsive to broadcast service information; updating the channel map to include channels of the broadcast service information and a channel selected by the user to produce an updated channel map; and changing a channel responsive to the updated channel map when a channel change is requested.

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 is a block diagram of a video receiving apparatus according to a first embodiment;

FIG. 2 illustrates an example of a conventional method of transmitting a broadcasting channel by a broadcasting signal;

FIG. 3 illustrates an example of a method of transmitting a broadcasting channel by a broadcasting signal based on a switched digital video (SDV) technology;

FIG. 4 illustrates an example of a method of transmitting a broadcasting signal by a broadcasting signal transmitting apparatus;

FIG. 5 is a flowchart showing a control method for forming a channel map by the video receiving apparatus in FIG. 1;

FIG. 6 is a flowchart showing a control method for changing a channel by the video receiving apparatus in FIG. 1;

FIG. 7 is a flowchart showing a control method of a broadcasting signal transmitting apparatus in FIG. 1; and

FIG. 8 is a block diagram of a video receiving apparatus according to a second embodiment.

### DETAILED DESCRIPTION

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

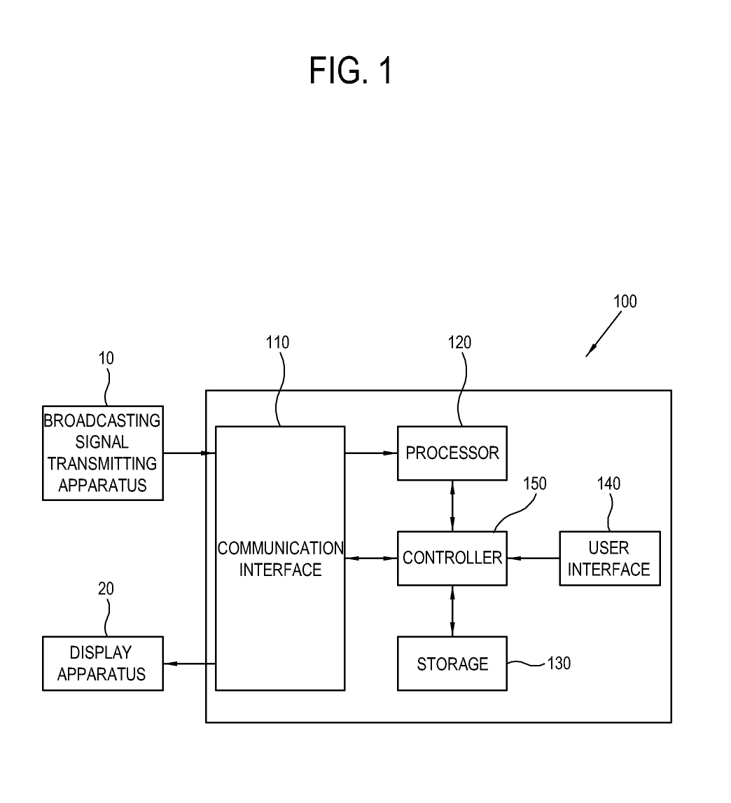

FIG. 1 is a block diagram of a video receiving apparatus 100 according to a first embodiment. The video receiving apparatus 100 according to the present embodiment refers to an apparatus which receives and processes a broadcast or broadcasting signal transmitted by a broadcasting or broadcast signal transmitting apparatus 10, and may output a processed broadcasting signal to another apparatus as well as receiving a broadcasting signal, and may transmit data/information to the broadcasting signal transmitting apparatus 10 depending on an embodiment type.

As shown in FIG. 1, the video receiving apparatus 100 receives a broadcasting signal from the broadcasting signal transmitting apparatus 10, and tunes and processes the broadcasting signal and outputs the processed broadcasting signal to a display apparatus 20. In the present embodiment, the video receiving apparatus 100 as a set-top box is explained, but the spirit of the embodiment may also apply to various other video receiving apparatuses. For example, the video receiving apparatus 100 may be implemented as a display apparatus such as a television (TV), and in such case, it may include a display panel (not shown) to display a broadcasting video thereon on its own.

The video receiving apparatus 100 includes a communication interface 110 to exchange various signals/information/data with the outside of the video receiving apparatus 100; a processor 120 to process a broadcasting signal transmitted by the broadcasting signal transmitting apparatus 10 through the communication interface 110; a storage 130 to store data therein; a user interface 140 to be manipulated by a user; and a controller 150 to control operations of overall elements of the video receiving apparatus 100.

The communication interface 110 receives a broadcasting signal in a wired manner or wirelessly from the broadcasting signal transmitting apparatus 10 of a broadcasting service provider, and transmits the broadcasting signal to the controller 150 and the processor 120. The communication interface 110 outputs the broadcasting signal processed by the controller 150 and the processor 120, to the display apparatus 20 to thereby display a broadcasting video by the display apparatus 20 based on the broadcasting signal.

The communication interface 110 may be connected to various external apparatuses/peripheral devices in addition to the broadcasting signal transmitting apparatus 10 and the display apparatus 20, and may be implemented by individual connection ports or connection modules for each apparatus. The communication interface 110 is herein explained to be embedded in the video receiving apparatus 100, but may be added, in whole or in part, as an add-on or dongle to the video receiving apparatus 100.

The communication interface 110 transmits and receives signals according to protocols designated for each apparatus connected thereto, and may transmit and receive signals based on an individual connection protocol for each apparatus connected thereto. For example, the communication interface 110 may transmit and receive signals based on various standards such as radio frequency (RF) signals, Composite/Component video, super video, SCART, high definition multimedia interface (HDMI), DisplayPort, unified display interface (UDI) or wireless HD.

The processor 120 performs various video processing operations with respect to a broadcasting signal. The processor 120 transmits the processed broadcasting signal to the communication interface 110 to provide the broadcasting signal to the display apparatus 20.

The video processing operations of the processor 120 may include, without limitation, tuning, decoding and de-interlacing operations, frame refresh rate conversion, noise reduction for improving a quality of a video, detail enhancement, etc. with respect to a broadcasting signal. The processor 120 may be implemented as an individual chipset to independently perform the aforementioned operations, or as a video processing board in which a system-on-chip performing integrated functions is mounted.

The storage 130 stores therein various data according to a control of the controller 150. The storage 130 may be implemented as a non-volatile memory such as a flash memory or a hard-disc drive to store data regardless of power supply for a system. The storage 130 is accessed by the controller 150 to read, write, modify, delete, or update data stored therein.

The user interface 140 transmits a preset control command to the controller 150 according to a user's manipulation and input to perform operations by the controller 150 corresponding to the command. The user interface 140 may be implemented as a menu key and an input panel installed in an external side of the video receiving apparatus 100 or a remote controller separated and spaced from the video receiving apparatus 100 or as other various types.

Otherwise, the user interface 140 may be implemented as a sensor to sense a user's various gestures, as a camera to photograph a user or as a microphone to detect a user's voice.

With the foregoing configuration, the controller 150 controls an operation for tuning and processing a broadcasting signal transmitted by the broadcasting signal transmitting apparatus 10, and an operation for outputting the processed broadcasting signal to the display apparatus 20. The broadcasting signal includes video data per channel in respective frequency bands, and the controller 150 tunes and processes the broadcasting signal to a frequency of a channel designated through the user interface 140.

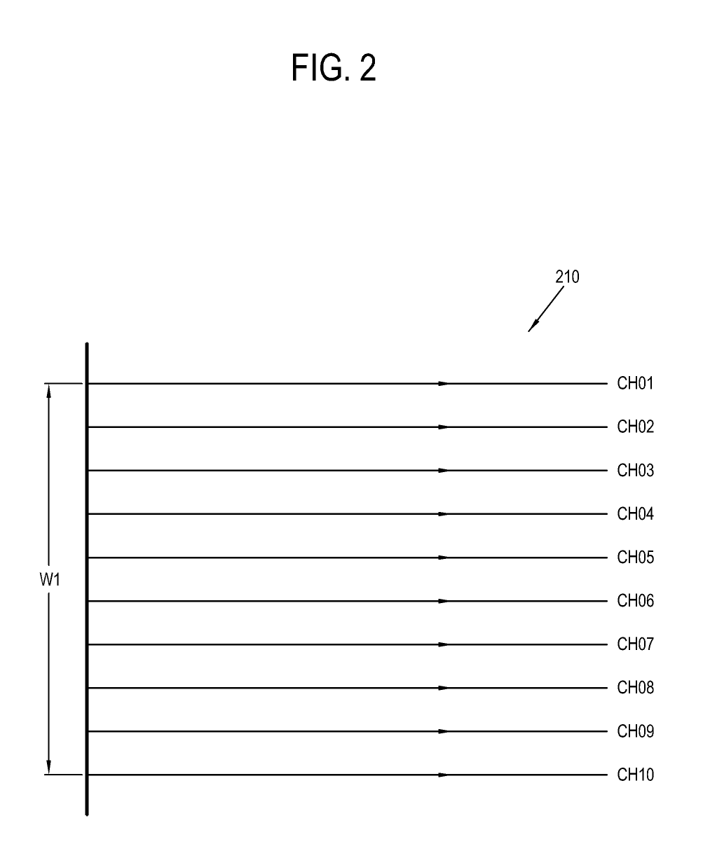

FIG. 2 illustrates an example of a conventional method of transmitting broadcasting or broadcast channels CH01 to CH10 by a broadcasting signal.

As shown therein, a broadcasting signal 210 may include, e.g., 10 channels CH01 to CH10. Since the respective channels CH01 to CH10 own or are in exclusive frequency bands, respectively, a frequency bandwidth W1 used by the broadcasting signal 210 is short if the number of the channels CH01 to CH10 is small, and long if the number of the channels CH01 to CH10 is large.

In a conventional method of transmitting the broadcasting signal 210 by the broadcasting signal transmitting apparatus 10, broadcasting data of all channels CH01 to CH10 are transmitted by being included in the broadcasting signal 210 regardless of whether a user views the broadcasting channels. There may be channels CH01 to CH10 which are less popular, or for the reason of time, there may be a small number of users and thus only a small number of the broadcasting channels CH01 to CH10 may be actually used. Notwithstanding the foregoing situations, the broadcasting signal 210 transmitted in a conventional manner carries all channels CH01 to CH10 and thus physical transmission bandwidths are wasted.

FIG. 2 illustrates only 10 channels CH01 to CH10 as an example, but given the current situation where the number of channels increases by several hundreds or thousands every time, there may be limitation in increasing the channels in the foregoing manner beyond the waste of transmission bandwidths.

Accordingly, broadcasting service providers uses a switched digital video (SDV) technology in transmitting a broadcasting signal to reduce the waste of the bandwidths of broadcasting channels.

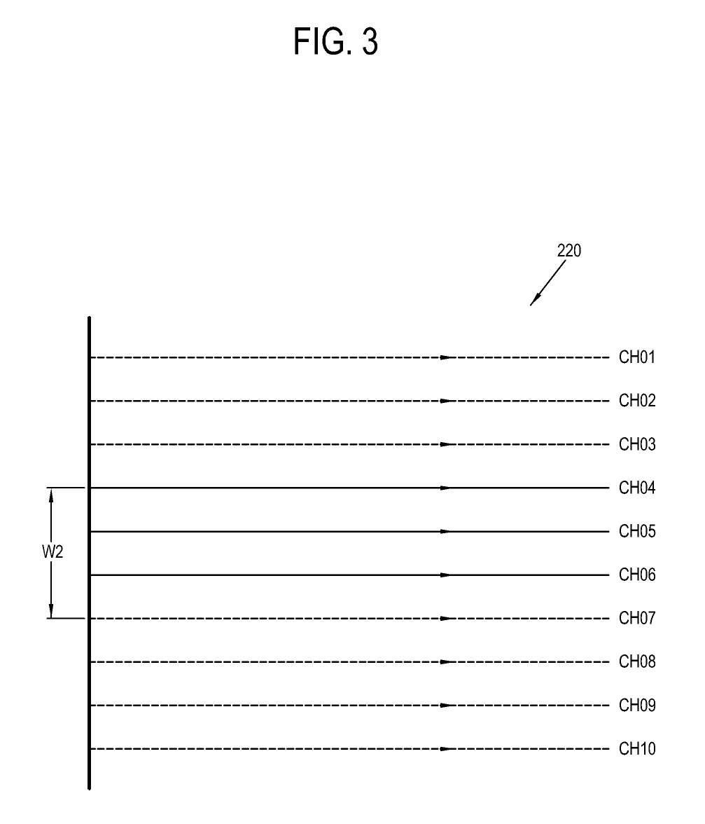

FIG. 3 illustrates an example of a method of transmitting broadcasting or broadcast channels CH01 to CH10 by a broadcast or broadcasting signal 220 based on the SDV technology.

As shown therein, the broadcasting signal 220 is transmitted by the broadcasting signal transmitting apparatus 10 to the video receiving apparatus 100 according to the SDV technology. If the broadcasting signal 220 includes 10 channels CH01 to CH10, such channels CH01 to CH10 are classified into basic channels CH04, CH05 and CH06 which are always included in the broadcasting signal 220, and optional transmission channels CH01, CH02, CH03, CH07, CH08, CH09 and CH10 which are optionally included in the broadcasting signal 220 at a request of a user. In FIG. 3, the basic channels CH04, CH05 and CH06 are shown as solid lines, and the optional transmission channels CH01, CH02, CH03, CH07, CH08, CH09 and CH10 are shown as dotted lines. The terms “basic channels” and “optional transmission channels” are given for convenience purpose only to show characteristics of the respective channels, and do not limit the spirit of the invention thereto.

In the present embodiment, the basic channels CH04, CH05 and CH06 are expressed as three channels with their channel numbers adjacent to one another, but such expression is only for convenience purpose to clarify the embodiment. The number of the basic channels CH04, CH05, CH06 is not limited, and the channel numbers of the basic channels may be designated to be adjacent or not adjacent to one another.

To change the channels CH01 to CH10 as instructed by a user, the video receiving apparatus 100 uses different processing methods with respect to the basic channels CH04, CH05 and CH06, and the optional transmission channels CH01, CH02, CH03, CH07, CH08, CH09 and CH10.

The video receiving apparatus 100 generates and stores therein a channel map including tuning information of the basic channels CH04, CH05 and CH06 based on system information or service information (SI) data provided by a broadcasting service provider. The SI data basically includes frequency band information for each channel to specify the channels CH01 to CH10 from the broadcasting signal 220 transmitted by the broadcasting signal transmitting apparatus 10. If a user instructs the video receiving apparatus 100 to change a channel to the basic channels CH04, CH05 and CH06, the video processing apparatus 100 specifies the channels CH04, CH05 and CH06 to which the channel is changed, based on the channel map, and tunes to the specified channels CH04, CH05 and CH06.

Unlike the basic channels CH04, CH05 and CH06, the optional transmission channels CH01, CH02, CH03, CH07, CH08, CH09 and CH10 are not always transmitted, and upon request from the video receiving apparatus 100, are transmitted by the broadcasting signal transmitting apparatus 10 after a frequency band is newly found. That is, tuning information of the optional transmission channels CH01, CH02, CH03, CH07, CH08, CH09 and CH10 is subject to change depending on the point of time or territory when/where the broadcasting signal transmitting apparatus 10 transmits the broadcasting signal 220. If a user instructs the video receiving apparatus 10 to change a channel to the optional transmission channels CH01, CH02, CH03, CH07, CH08, CH09 and CH10, the video receiving apparatus 10 receives the tuning information of the optional transmission channels CH01, CH02, CH03, CH07, CH08, CH09 and CH10 from the broadcasting signal transmitting apparatus 10 or from an additional server (not shown) provided by the broadcasting service provider through the communication interface 110, and changes the channel to the optional transmission channels CH01, CH02, CH03, CH07, CH08, CH09 and CH10 based on the provided tuning information.

By using the SDV technology, the frequency bandwidth may be less used by the broadcasting signal 220 than in the case of FIG. 2. For example, if the channel CH07 of the optional transmission channels CH01, CH02, CH03, CH07, CH08, CH09 and CH10 is to be viewed, it can be known that a frequency bandwidth W2 used by the broadcasting signal 220 is significantly shorter than the frequency bandwidth W1 in FIG. 2.

Channel zapping time for the basic channels CH04, CH05 and CH06 and the optional transmission channels CH01, CH02, CH03, CH07, CH08, CH09 and CH10 based on the SDV technology is as follows.

A channel zapping time Tn from a current channel to the basic channels CH04, CH05 and CH06 is the same as the processing time of the processor 120. The processing performed by the processor 120 includes analysis, tuning, and decoding time for the SI data.

A channel zapping time Ts from a current channel to the optional transmission channels CH01, CH02, CH03, CH07, CH08, CH09 and CH10 is the sum of the processing time of the processor 120 and the request processing time of the communication interface 110. The request processing time of the communication interface 110 includes time taken to request the broadcasting signal transmitting apparatus 10 to transmit the optional transmission channels CH01, CH02, CH03, CH07, CH08, CH09 and CH10 selected by a user, and taken to transmit by the broadcasting signal transmitting apparatus 10 the broadcasting signal 220 including the optional transmission channels CH01, CH02, CH03, CH07, CH08, CH09 and CH10 and updated tuning information to the video receiving apparatus 100. That is, changing the channel to the optional transmission channels CH01, CH02, CH03, CH07, CH08, CH09 and CH10 requires more time than changing the channel to the basic channels CH04, CH05 and CH06.

Accordingly, a user should wait for a longer time when the channel is changed to the optional transmission channels CH01, CH02, CH03, CH07, CH08, CH09 and CH10 than to the basic channels CH04, CH05 and CH06. This may decrease the degree of satisfaction to the broadcasting service environment including the video receiving apparatus 100. In particular, if a broadcasting service provider increases the portion of the optional transmission channels CH01, CH02, CH03, CH07, CH08, CH09 and CH10 within the broadcasting signal 220 to reduce the usage of the frequency bandwidth, such delay increases further.

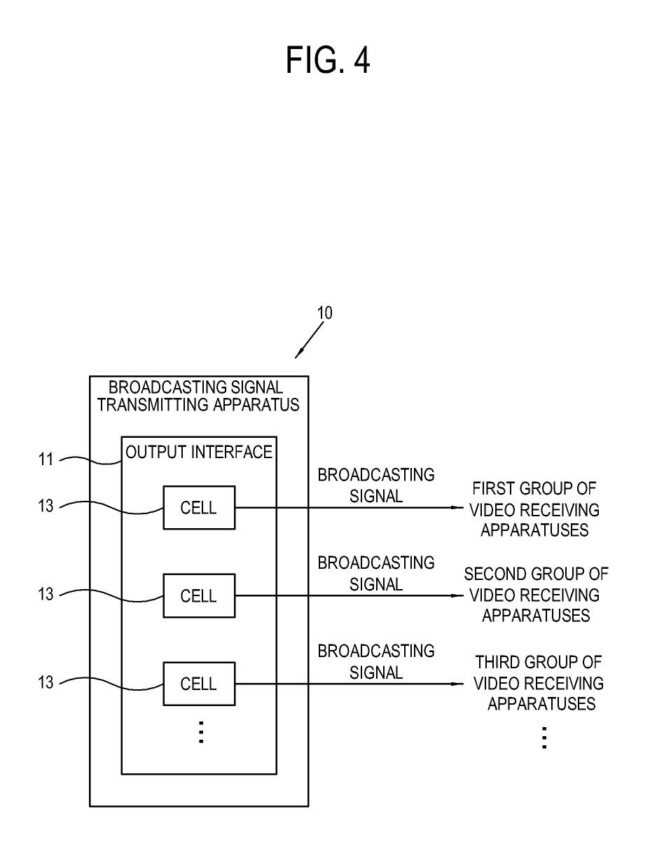

FIG. 4 illustrates an example of a method of transmitting a broadcast or broadcasting signal by the broadcasting or broadcast signal transmitting apparatus 10.

As shown therein, the broadcasting signal transmitting apparatus 10 outputs broadcasting signals to a plurality of video receiving apparatuses 100 connected thereto. The video receiving apparatuses 100 to which the broadcasting signals are transmitted is formed as groups, and the broadcasting signal transmitting apparatus 10 decides tuning information of respective groups, and outputs the broadcasting signals according to the decided tuning information.

Methods of grouping the video receiving apparatuses 100 may vary. For example, the video receiving apparatuses 100 may be grouped per administrative district where the video receiving apparatuses 100 are located, or per district as set by a broadcasting service provider. Otherwise, the video receiving apparatuses 100 may be grouped on the basis of a user profile of the video receiving apparatuses 100 registered with a broadcasting service provider, or per service category provided by a broadcasting service provider. As such, the methods of grouping the video receiving apparatuses 100 are not limited, and may vary.

The broadcasting signal transmitting apparatus 10 includes an output interface 11 to output a broadcasting signal. Since the output interface 11 may output a broadcasting signal based on a plurality of respective tuning information, a unit of the output interface 11 which outputs a broadcasting signal according to single tuning information is called a cell 13. That is, the output interface 11 includes a plurality of cells 13 to output broadcasting signals based on tuning information decided individually, and a broadcasting signal transmitted by a single cell 13 is commonly output to a single group of video receiving apparatuses 100.

For example, if the broadcasting signal transmitting apparatus 10 receives a request from the video receiving apparatus 100 to transmit the optional transmission channels, it determines which group includes the video receiving apparatus 100 that has requested the optional transmission channels. The broadcasting signal transmitting apparatus 10 outputs a broadcasting signal including the optional transmission channels as requested and tuning information used to tune the optional transmission channels, through the cell 13 corresponding to the group of the video receiving apparatus 100.

The video receiving apparatus 100 tunes the broadcasting signal including the optional transmission channels based on the tuning information output by the broadcasting signal transmitting apparatus 10, and processes the broadcasting signal to display a desired broadcasting video of the optional transmission channels.

Even if a user views the same optional transmission channel, a frequency band of a certain channel in a broadcasting signal output to the video receiving apparatuses 10 of a first group may be different from a frequency band of the channel in a broadcasting signal output to the video receiving apparatuses 100 of a second group.

With the foregoing configuration of transmitting a broadcasting signal, the following method is offered in the present embodiment.

The controller 150 of the video receiving apparatus 100 generates and stores a channel map based on tuning information of basic channels provided by the broadcasting signal transmission apparatus 10. If another video receiving apparatus which belongs to the same group as the former video receiving apparatus 100 receives the optional transmission channels, the controller 150 updates the stored channel map by using the tuning information of the optional transmission channels.

If a user instructs the controller 150 to change the channel to the optional transmission channels, the controller 150 changes the channel based on the updated channel map.

The fact that the channel to be changed is included in the updated channel map means that a broadcasting signal received by the video receiving apparatus 100 includes data of the channel. The fact that the channel to be changed is not included in the updated channel map means that a broadcasting signal received by the video receiving apparatus 100 does not include data of the channel. This is because the broadcasting data included in the broadcasting signal and the tuning information used to tune the broadcasting signal are the same with respect to the video receiving apparatuses 100 of the same group.

Accordingly, if the channel to be changed is included in the stored channel map, the controller 150 tunes the broadcasting signal based on the stored channel map without requesting the broadcasting signal transmitting apparatus 10 to transmit the channel.

If the channel to be changed in not included in the stored channel map, the controller 150 requests the broadcasting signal transmitting apparatus 10 to transmit the channel, and receives from the broadcasting signal transmitting apparatus 10 and processes the updated broadcasting signal and tuning information. The broadcasting signal and tuning information output by the broadcasting signal transmitting apparatus 10 are the same with respect to the video receiving apparatuses 100 of the same group, and thus other video receiving apparatuses in the same group may operate mutatis mutandis according to the video receiving apparatus 100 according to the present embodiment.

If the controller 150 determines that any optional transmission channel which is viewed by no other video receiving apparatuses 100 of the same group is included in the channel map, it deletes the optional transmission channel from the channel map. This means that the controller 150 deletes tuning information of the optional transmission channel from the channel map.

In the video receiving apparatus 100 which uses the aforementioned method, a channel zapping time which is taken when a user instructs to change a channel is as follows.

A channel zapping time which is taken when a user instructs to change a current channel to the basic channel is a processing time Tn of the processor 120. That is, after Tn elapses from the time when a user instructs to change a channel, a broadcasting video of a desired channel is displayed.

If a user instructs to change a current channel to the optional transmission channels, two types of the channel zapping time is taken as follows:

If the optional transmission channel to which the channel is changed is not included in the stored channel map, the channel zapping time is the sum Ts of the processing time Tn of the processor 120 and the request processing time of the communication interface 110. Since the broadcasting signal does not include data of a desired channel, a longer time Ts than the processing time Tn is required.

If the optional transmission channel to which the channel is changed is included in the stored channel map, the channel zapping time is the processing time Tn which is the same as that taken to change to the basic channels. This is because broadcasting data of the desired optional transmission channel are included in the currently received broadcasting signal and thus the channel is turned on the basis of the stored channel map like in the case of the basic channels.

The broadcasting signal transmitting apparatus 100 operates as follows.

The broadcasting signal transmitting apparatus 10 outputs a broadcasting signal including initial basic channels and tuning information used to tune the basic channels with respect to the video receiving apparatuses 100 of a certain group. By doing so, the respective video receiving apparatuses 100 of the group generate a channel map based on the tuning information provided by the broadcasting signal transmitting apparatus 10.

If any of the video receiving apparatuses 100 of the group requests the broadcasting signal transmitting apparatus 10 to change a channel to the optional transmission channels, the broadcasting signal transmitting apparatus 10 outputs a broadcasting signal including the optional transmission channel and tuning information used to tune the optional transmission channels to the group. Then, the respective video receiving apparatuses 100 of the group update the channel map which has been generated and stored previously.

If the broadcasting signal transmitting apparatus 100 determines that no video receiving apparatus 100 of the group views the optional transmission channel, it excludes the optional transmission channel from the broadcasting signal. Such determination may be made according to various embodiments, e.g., by providing information of a channel that is currently displayed by the video receiving apparatus 100 to the broadcasting signal transmitting apparatus 10 and using the information provided as above.

According to the present embodiment, the video receiving apparatus 100 may reduce the channel zapping time when the optional transmission channel to which the channel is changed is included in the stored channel map, compared to a conventional art. Also, the number of accesses made by the video receiving apparatuses 100 to the broadcasting signal transmitting apparatus 10 or a server (not shown) to request for the optional transmission channel may be reduced.

In the foregoing embodiment, if the number of the video receiving apparatuses 100 of a group or users exceeds a predetermined threshold value, tuning information of all optional transmission channels may be statistically stored in the respective video receiving apparatuses 100. In this case, the channel zapping time for all channels in a broadcasting signal becomes Tn, and the frequency bandwidth used by the broadcasting signal increases but the channel zapping time may be reduced.

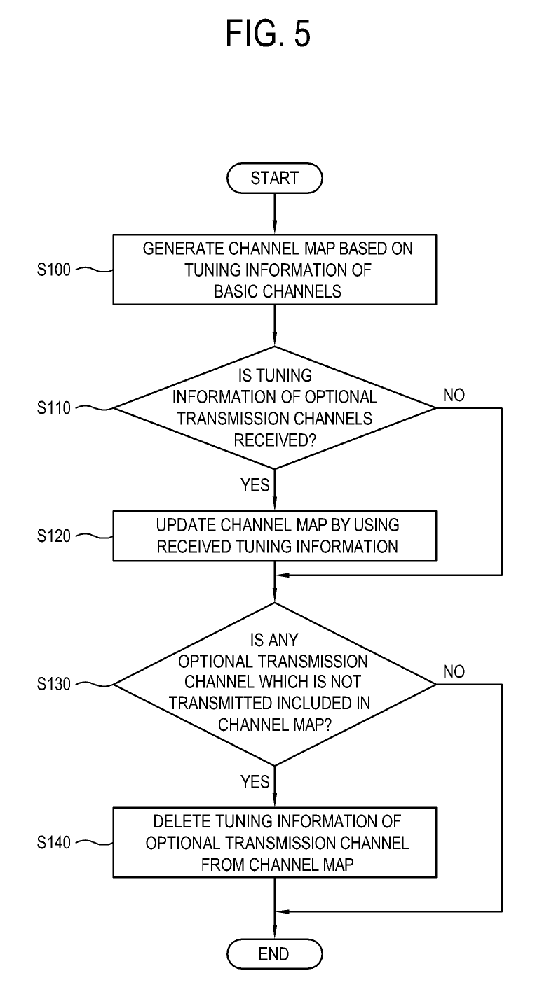

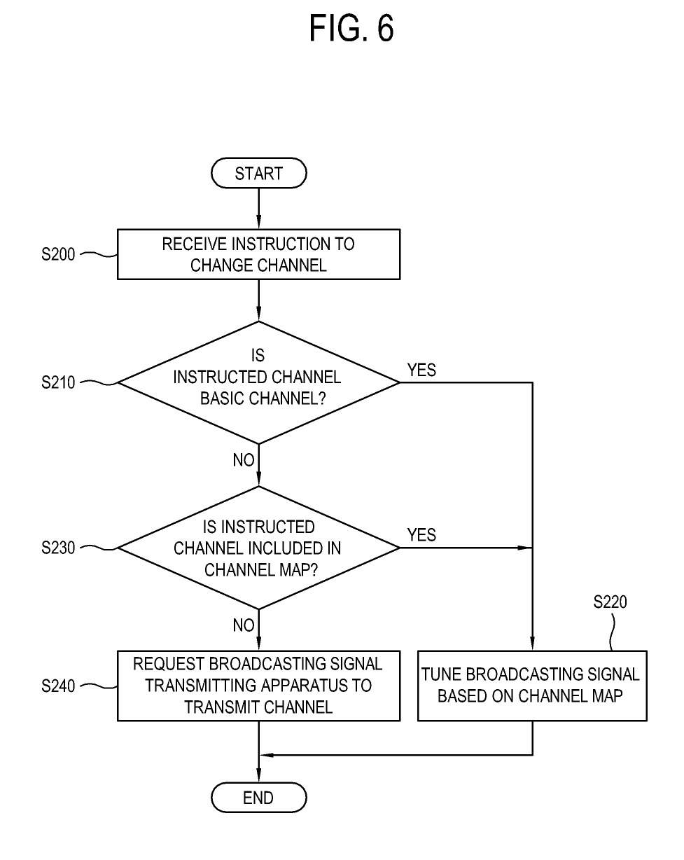

Hereinafter, a control method of the video receiving apparatus 100 according to the present embodiment will be described with reference to FIGS. 5 and 6.

FIG. 5 is a flowchart showing a control method for forming a channel map by the video receiving apparatus 100.

As shown therein, the video receiving apparatus 100 generates the channel map based on the tuning information of the basic channels provided by the broadcasting or broadcast signal transmitting apparatus 100 (S100).

The video receiving apparatus 100 determines whether the tuning information of the optional transmission channels is provided by the broadcasting signal transmitting apparatus 100 (S110). If the tuning information of the optional transmission channels is provided, the video receiving apparatus 100 updates the channel map by using the received tuning information (S120).

The video receiving apparatus 100 determines whether any optional transmission channel which is not transmitted by the broadcasting signal transmitting apparatus 10 is included in the channel map (S130). Such determination may be made by receiving a notice from the broadcasting signal transmitting apparatus 100 notifying that a particular optional transmission channel is not included in a broadcasting signal. If it is determined that the non-transmission optional transmission channel is included in the channel map, the video receiving apparatus 100 delete tuning information of the optional transmission channel from the channel map (S140).

FIG. 6 is a flowchart showing a control method for changing a channel by the video receiving apparatus 100.

As shown in therein, the video receiving apparatus 100 receives a user's instruction regarding changing a channel (S200).

The video receiving apparatus 100 determines whether the instructed channel is a basic channel (S210). If yes, the video receiving apparatus 100 tunes the broadcasting or broadcast signal based on the channel map (S220).

If the channel is not a basic channel but an optional transmission channel, the video receiving apparatus 100 determines whether the channel is included in the channel map (S230).

If the channel is included in the channel map, the video receiving apparatus 100 tunes the broadcasting signal based on the channel map (S220).

If the channel is not included in the channel map, the video receiving apparatus 100 requests the broadcasting signal transmitting apparatus 10 to transmit the channel (S240).

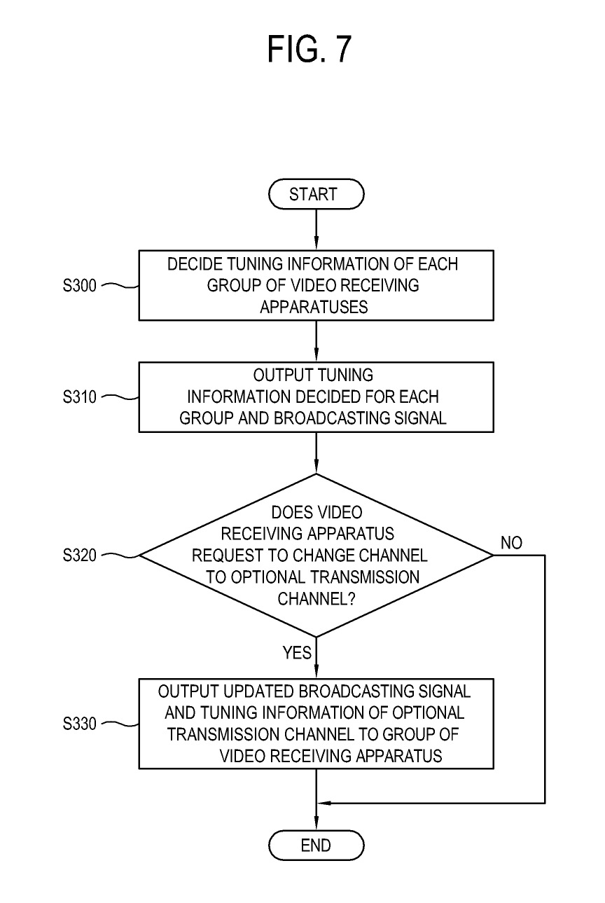

FIG. 7 is a flowchart showing a control method of the broadcast or broadcasting signal transmitting apparatus 10.

As shown therein, the broadcasting signal transmitting apparatus 10 decides tuning information of each group of the video receiving apparatuses 100 (S300). The broadcasting signal transmitting apparatus 10 outputs the tuning information and broadcasting signal for each group (S310).

The broadcasting signal transmitting apparatus 10 receives a request from the video receiving apparatus 100 of a predetermined group to change the channel to the optional transmission channel (S320). The broadcasting signal transmitting apparatus 10 outputs the updated broadcasting signal and tuning information of the optional transmission channel (S330). That is, the broadcasting signal transmitting apparatus 10 outputs the tuning information of the requested optional transmission channel and the broadcasting signal including the optional transmission channel to the group.

As explained above, if the video receiving apparatus is included in a predetermined first group out of a plurality of groups of video receiving apparatuses receiving a broadcasting signal from the broadcasting signal transmitting apparatus, the video receiving apparatus receives a broadcasting signal transmitted by the broadcasting signal transmitting apparatus based on the tuning information of the channel set for the first group separately from other groups. The video receiving apparatus processes the broadcasting signal to display a broadcasting video of a channel based on the channel map generated by using the tuning information, and generates and stores the channel map when initially receiving the broadcasting signal including the basic channels. If it is determined that another video receiving apparatus of the first group displays a broadcasting video of an additional channel that is not included in the broadcasting signal transmitted at the time of generating the channel map, the stored channel map is updated by using the tuning information of the additional channel.

If a user instructs to change the channel to the additional channel, the video receiving apparatus tunes the broadcasting signal based on the updated channel map without requesting the broadcasting signal transmitting apparatus to transmit the channel, to thereby reduce the channel zapping time.

The foregoing configuration may be provided in a SDV-based environment.

In the foregoing embodiment, it has been explained that the video receiving apparatus 100 may exchange information with the broadcasting signal transmitting apparatus 10 through the communication interface 110 of the video receiving apparatus 100. However, there may be a case where the communication interface 110 of the video receiving apparatus 100 may not support the foregoing operation due to various reasons including support or non-support of protocols depending on apparatuses.

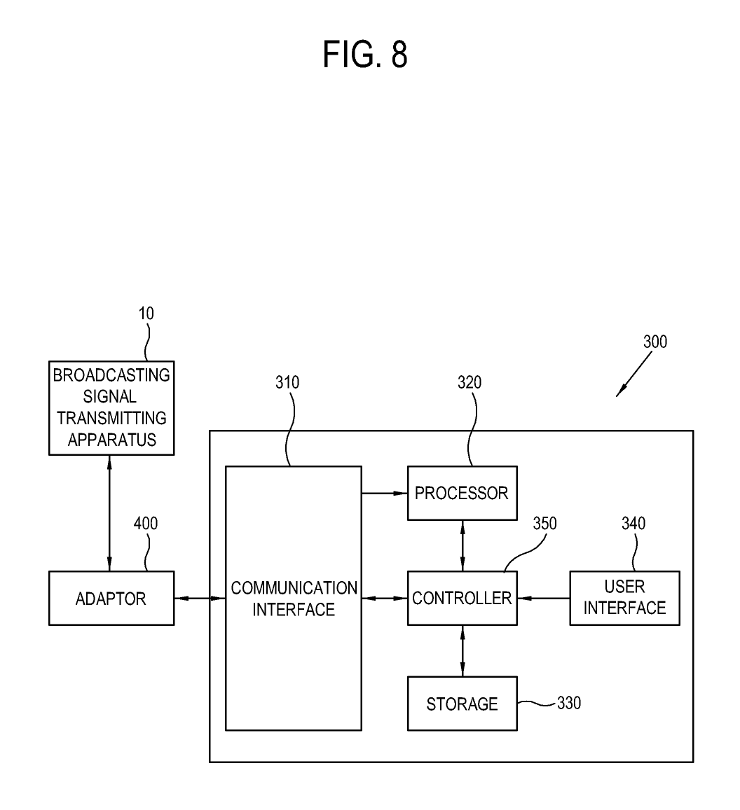

FIG. 8 is a block diagram of a video receiving apparatus 300 according to a second embodiment.

As shown therein, the video receiving apparatus 300 includes a communication interface 310, a processor 320, a storage 330, a user interface 340 and a controller 350.

The communication interface 310 may not be directly connected to the broadcast or broadcasting signal transmitting apparatus 100 or an additional server (not shown) and exchange information therewith. In such a case, the communication interface 310 is connected to an adaptor 400 that is additionally provided, to be connected to the broadcasting signal transmitting apparatus 10 through the adaptor 400 for communication.

The adaptor 400 acts as a communication intermediary to transmit information/data from the broadcasting signal transmitting apparatus 10 to the communication interface 310, and to transmit information/data from the communication interface 310 to the broadcasting signal transmitting apparatus 10. During the foregoing process, the adaptor 400 may convert a protocol or information, and may be controlled by the controller 350 as necessary.

Detailed operations of the processor 320, the storage 330, the user interface 340 and the controller 350 may employ the foregoing embodiment, and thus will not be explained in detail.

Although a few exemplary embodiments have been shown and described, it will be appreciated by those skilled in the art that changes may be made in these exemplary embodiments without departing from the principles and spirit of the invention, the range of which is defined in the appended claims and their equivalents.

What is claimed is:

1. A video receiving apparatus of a predetermined first group out of a plurality of groups of video receiving apparatuses which receive a broadcast signal from a broadcast signal transmitting apparatus, the video receiving apparatus comprising:
a communication interface which receives a broadcast signal from the broadcast signal transmitting apparatus based on tuning information of a channel that is set for the first group separately from other groups;
a processor which processes the broadcast signal to display a broadcast video of the channel based on a channel map generated by using the tuning information; and
a controller which generates and stores the channel map when receiving the broadcast signal comprising one or more basic channels, and if it is determined that another video receiving apparatus in the first group displays a broadcast video of an additional channel not in the broadcast signal transmitted when the stored channel map is generated, updates the stored channel map by using tuning information of the additional channel.

2. The video receiving apparatus according to claim 1, wherein the additional channel is optionally in the broadcast signal transmitted by the broadcast signal transmitting apparatus to the first group at a request from at least one of the plurality of video receiving apparatuses in the first group, and the basic channels are in the broadcast signal regardless of the request.

3. The video receiving apparatus according to claim 1, wherein, if a user instructs a channel change of a channel to a first channel, the controller determines whether the first channel is in the basic channels or the additional channel, and if it is determined that the first channel is the additional channel and the tuning information of the first channel is in the channel map, processes the broadcast signal based on the channel map.

4. The video receiving apparatus according to claim 3, wherein if it is determined that the first channel is the additional channel and the tuning information of the first channel is not in the channel map, the controller requests the broadcast signal transmitting apparatus to transmit the broadcast signal comprising the first channel and the tuning information of the first channel.

5. The video receiving apparatus according to claim 3, wherein if it is determined that the first channel is the basic channel, the controller processes the broadcast signal based on the channel map.

6. The video receiving apparatus according to claim 1, wherein if the broadcast signal transmitting apparatus transmits the tuning information of the additional channel that is not in the stored channel map, the controller determines that another video receiving apparatus of the first group displays a broadcast video of an additional channel that is not in the broadcast signal transmitted when the stored channel map was generated.

7. The video receiving apparatus according to claim 1, wherein if it is determined that the tuning information of the additional channel currently displayed by no other video receiving apparatuses of the first group is included in the stored channel map, the controller deletes the tuning information of the additional channel from the stored channel map.

8. The video receiving apparatus according to claim 1, wherein the inclusion and non-inclusion of the additional channel by the broadcast signal and the tuning information used to specify the additional channel from the broadcast signal apply to the plurality of video receiving apparatuses of the first group.

9. The video receiving apparatus according to claim 1, wherein a frequency band of the additional channel from the broadcast signal is individually decided with respect to the plurality of groups, and the tuning information corresponding to the first group comprises information used to specify a frequency band of the additional channel from the broadcast signal transmitted to the first group.

10. The video receiving apparatus according to claim 1, wherein the broadcast signal is provided by the broadcast signal transmitting apparatus to the video receiving apparatus based on a switched digital video (SDV) technology.

11. A control method of a video receiving apparatus of a predetermined first group out of a plurality of groups of video receiving apparatuses which receive a broadcast signal from a broadcast signal transmitting apparatus, the control method comprising:
receiving a broadcast signal comprising one or more basic channels which is transmitted by the broadcast signal transmitting apparatus based on tuning information of a channel for the first group separately from the other groups;
generating a channel map based on the tuning information;
updating the stored channel map by using tuning information of an additional channel that is not in the broadcast signal transmitted when the channel map is generated if it is determined that another video receiving apparatus in the first group displays a broadcast video of the additional channel; and
processing the broadcast signal based on the updated channel map if an instruction for changing a channel is received.

12. The control method according to claim 11, wherein the additional channel is optionally in the broadcast signal transmitted by the broadcast signal transmitting apparatus to the first group at a request from at least one of the plurality of video receiving apparatuses in the first group, and the basic channels are in the broadcast signal regardless of the request.

13. The control method according to claim 11, wherein the processing the broadcast signal based on the updated channel map if the instruction for changing the channel is received comprises determining whether the first channel is included in the basic channels or the additional channel if a user instructs a channel change of a channel to the first channel; and
processing the broadcast signal based on the channel map if it is determined that the first channel is the additional channel and the tuning information of the first channel is in the channel map.

14. The control method according to claim 13, wherein the processing the broadcast signal based on the updated channel map if the instruction for changing the channel is received further comprises requesting the broadcast signal transmitting apparatus to transmit the broadcast signal comprising the first channel and the tuning information of the first channel if it is determined that the first channel is the additional channel and the tuning information of the first channel is not in the channel map.

15. The control method according to claim 13, wherein the processing the broadcast signal based on the updated channel map if the instruction for changing the channel is received further comprises processing the broadcast signal based on the channel map if it is determined that the first channel is the basic channel.

16. The control method according to claim 11, wherein the updating the stored channel map by using the tuning information of the additional channel comprises determining that another video receiving apparatus of the first group displays a broadcast video of an additional channel that is not in the broadcast signal transmitted when the channel map is generated, if the tuning information of the additional channel which is not in the channel is transmitted by the broadcast signal transmitting apparatus.

17. The control method according to claim 11, further comprising deleting the tuning information of the additional channel from the stored channel map if it is determined that the tuning information of the additional channel that is currently displayed by no other video receiving apparatuses of the first group is in the stored channel map.

18. The control method according to claim 11, wherein the inclusion and non-inclusion of the additional channel by the broadcast signal and the tuning information used to specify the additional channel from the broadcast signal commonly apply to the plurality of video receiving apparatuses of the first group.

19. The control method according to claim 11, wherein a frequency band of the additional channel in the broadcast signal is individually decided for each of the plurality of groups, and the tuning information corresponding to the first group comprises information used to specify a frequency band of the additional channel in the broadcast signal.

20. The control method according to claim 11, wherein the broadcast signal is provided by the broadcast signal transmitting apparatus to the video receiving apparatus based on an SDV technology.
